(19) United States
(12) Patent Application Publication
(10) Pub. No.: US 2005/0192826 A1
(43) Pub. Date: Sep. 1, 2005

(54) Grant, management and reporting system and method

(76) Inventor: Norman Kanefsky, Cherry Hill, NJ (US)

Correspondence Address: SCHNADER HARRISON SEGAL & LEWIS, LLP, 1600 MARKET STREET, SUITE 3600, PHILADELPHIA, PA, 19103, US

(21) Appl. No.: 10/922,455

(22) Filed: Aug. 20, 2004

Related U.S. Application Data
(60) Provisional application No. 60/496,826, filed on Aug. 21, 2003.

(51) Int. Cl. G06F 17/60; G06F 13/362

(52) U.S. Cl. 705/1

(57) ABSTRACT

A method and system for managing and reporting grants is disclosed and comprises a processor (18) and a data store (19). A regulatory form associated with a grant (22) which is used by a grantor (12) to administer the grant. A grant set-up module (50) is provided for collecting data associated with the grant which is stored in the data store. A grantee data entry module (60) is provided in which the grantee can enter data related to the grant set-up data which is stored in the data store, the grantee data and the grant set-up data can be compared by the processor to enable a grantor to track the status of the grant.

### FIELD OF THE INVENTION

The invention relates to a grant management and reporting system and method, and in particular, to an automated method and system for automatically reporting and managing grantee activities to grantors in a prescribed format which also allows the grantor to look into ongoing spending activities of the grantees.

### BACKGROUND OF THE INVENTION

Presently, there exists many grant programs wherein grantors provide funding to grantees. Typically, the performance of some task is required of the grantee in order to fulfill the conditions of the grant. In the United States, there are currently over 1,400 federal programs, representing approximately $500 billion and approximately 1 million new grants per year and 5-6 million that are active at any given time. OMB is actively involved in implementing the Federal Financial Assistance Management Improvement Act, which was signed into law on Nov. 20, 1999. OMB has discovered that there has been poor reporting and a dramatic lack of accountability for a significant portion of this grant activity. The federal grantor organizations have not been able to receive timely and accurate information as to how the grantees, or recipients, have spent much of the grant funding. When reporting does occur, it is typically months after the grant period has ended and reconciliation between the grantor and grantee financial and performance records is difficult, if not impossible in some cases.

To date, there has been no attempted solution to this problem. Federal grantor agencies have focused on upgrading their in-house financial systems and the JFMIP (Joint Financial Management Improvement Program) under the authority of the CFO counsel, has produced requirements for federal agencies to account for their grants. However, the present systems that track transactions, and manage the disbursing of funds, only affect the books of the grantor agency. On the other hand, the grantee community has been trying to account for grants using their own specialized systems. For example, hospitals are using hospital accounting systems and colleges are using educational institution systems. There is no present accounting for the grants in the manner that is consistent with federal requirements, i.e., OMB, Congress, GAO, and Treasury. There is no automated system at the present time that automatically reports activities in the prescribed format. This is now being performed manually. In addition, there are no systems in place today that allow the grantor to look into the ongoing spending activities of the recipients.

### SUMMARY OF THE INVENTION

A method and system for managing and reporting grants is disclosed and comprises a processor and a data store. A regulatory form associated with a grant which is used by a grantor to administer the grant. A grant set-up module is provided for collecting data associated with the grant which is stored in the data store. A grantee data entry module is provided in which the grantee can enter data related to the grant set-up data which is stored in the data store, the grantee data and the grant set-up data can be compared by the processor to enable a grantor to track the status of the grant. The grantee data can be used to populate the at least one of the regulatory form. Authorized third parties may be permitted access to the system data. The grant may include performance criteria and the grantee data may comprise data related to the performance criteria.

In one form of the invention, a payment system module may be provided for collecting funding data related to the grant disbursed by a payment system, the funding data is available to the grantor to administer the grant.

In another form of the invention, a standard general ledger module can be provided for formatting system data in standard general ledger format for use in the grantor's financial software.

One objective of the present invention is to report the results of grant activities in the proper format to various administrative agencies such as Congress, OMB, GAO, or Treasury.

Another objective is to report available information on demand and produce the information required by the OMB Forms 269, 270 and 272.

Another objective is to allow the grantor to monitor the activities of grantees online and preferably in real time.

Another objection is to make this information available online.

Another objective is that data is provided in a format that can be automatically uploaded to the grantor or grantee's financial system.

Another objective is that information can be reviewed by a grant officer who can advise the grantee that revision is potentially necessary or required.

Another objective is that notifications are possible to either the grantor or the grantee.

### BRIEF DESCRIPTION OF THE DRAWINGS

For the purpose of illustrating the invention, there is shown in the drawings a form of the invention that is presently preferred; it being understood, however, that this invention is not limited to the precise arrangements and instrumentalities shown.

FIG. 1 is a schematic view of a preferred grant management and reporting system and method, as disclosed by the present invention;

FIG. 2 is a schematic representation of the grant management and reporting system shown in FIG. 1;

FIG. 3 is another schematic view of the grant management and reporting system of FIG. 1 illustrating a preferred arrangement of grantors and grantees along with a local node of the system;

FIG. 4 is a more complete schematic representation of the grant management and reporting system of FIG. 1 showing the flow of data in the system; and

FIG. 5 is a schematic view of the grant management and reporting system of FIG. 1 showing in more detail the data that is passed between the grantor and the grantee.

### DETAILED DESCRIPTION OF THE PREFERRED EMBODIMENT

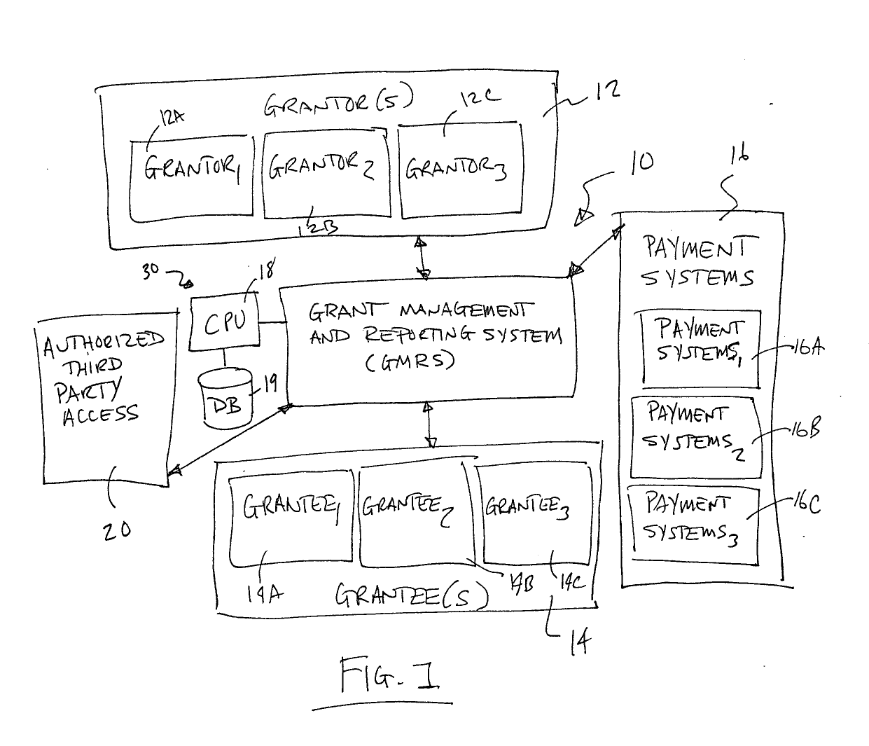

In FIGS. 1-5, there is shown a preferred method and system for managing and reporting grants 10 in accordance with the present invention.

FIG. 1 illustrates the grant management and reporting system (GMRS) 10 interface between grantor 12 and grantee 14. It should be understood that grantor 12 may include a plurality of grantors 12A, 12B and 12C depending upon the number of grants that are being administered. Likewise, it should be understood that grantee 14 may include any number of grantees 14A, 14B, 14C depending upon the number of grantees that are interested in obtaining funding on the outstanding grants. For example, on the U.S. Federal level a grantor 12 can be almost any of the federal agencies. It should be understood that the invention of the present invention also contemplates any type of grantor, such as grantors that are at the state or local level, nonprofit or private, or the like. For simplicity of describing the current invention, this application will focus on U.S. federal grantors since a large grant framework exists for administering these federal grants. However, it should be understood that the present invention applies to any type of grantor and any type of grant administering system.

A payment system 16 may also be associated with the GMRS 10 of the present invention. The payment system 16 serves as a system for distributing the grant funds. On the U.S. federal level, such payment systems exist and include the ASAP payment system of the US Treasury, the PMS payment system of the US Health and Human Services (HHS), private banks, and other financial institutions. It should be understood that the payment system 16 may include any number of participating payment systems 16A, 16B, 16C depending upon the grant being administered.

The GMRS 10 of the present invention can preferably comprise a software computer program running on a central processing unit 18 having a data store 19, such as a local database. In one form of the present invention the software that comprises the GMRS 10 can reside on a local server at a grantee's site or a grantor's site. In another preferred form of the invention, the GMRS 10 server can reside at a third party site that administers the system in which the grantor 12 and the grantee 14 has access to the system via a remote interface, such as a web browser interface over the global computer network.

In addition, the GMRS 10 of the present invention contemplates that authorized third party access 20 may be provided to effect a desired function of the grant process, such as auditing or otherwise monitoring the grant system. For example, suitable third parties may be a CFO, an auditor, the inspector general, Congress, and OMB, or the like. These authorized third parties 20 can have limited or full access to the GMRS 10 as desired.

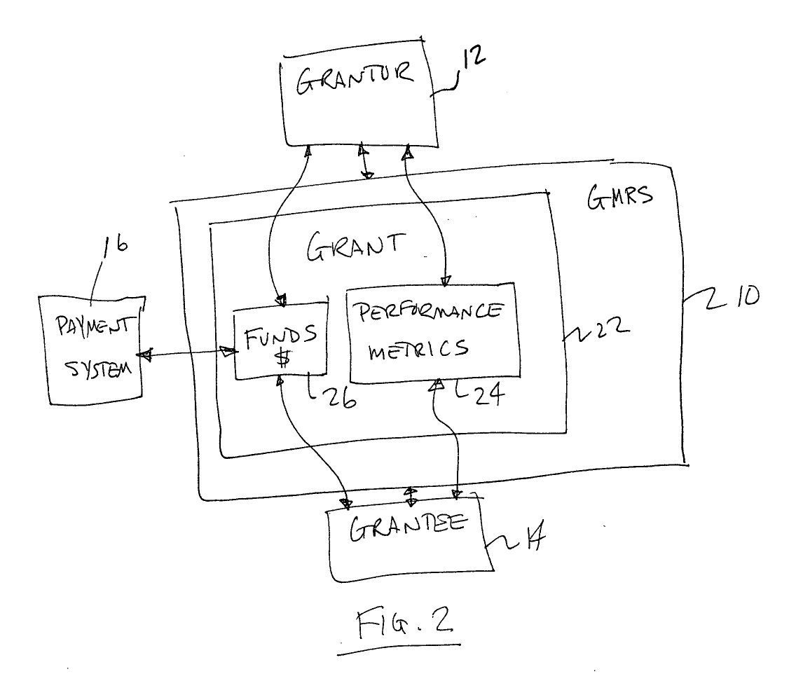

Turning now to FIG. 2, a typical grant process is illustrated. In a typical grant process, a grant 22 is made available by the grantor 12 to the grantee 14. Typically, the grant 22 comprises at least one performance criterion 24 that the grantee must complete and funding 26 that is to be distributed to the grantee 14. However, it should be understood that many grants have no associated performance criteria. Typically, a payment system 16 forms part of the grant processing system and is responsible for administering the payment of the funds 26 to the grantee. In such a system, funds 26 are transferred from the grantor 12 to the grantee 14 under the auspices of the GMRS 10 of the present invention, as described in greater detail below. Similarly, as the performance criteria 24 are fulfilled by the grantee they can be reported to the grantor via the GMRS 10, as described in greater detail below. Although not shown, various third party auditors and the like 20 may also have access to the GMRS 10.

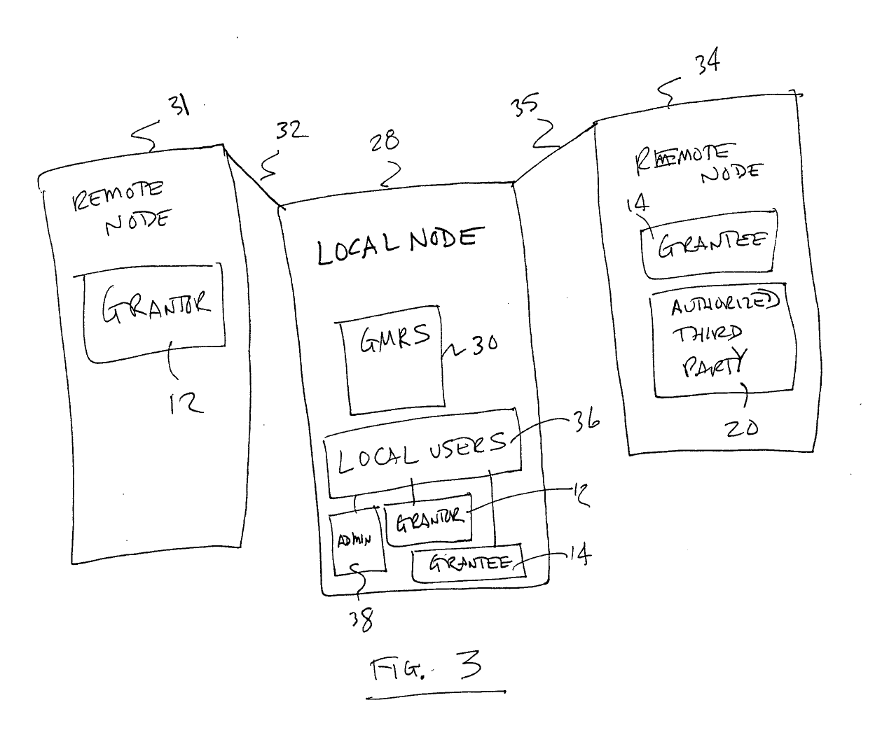

Turning now to FIG. 3, there is shown various configurations of the GMRS 10 of the present invention. As discussed previously, the GMRS 10 typically includes a server 30 running the GMRS software. This GMRS server 30 is typically located at a local node 28. Local users 36 have direct access to the GMRS server 30 at the local node 28. In addition, local grantors 12 and grantees 14 may also have direct access to the GMRS server 30. In addition, application administrators 38 may also comprise a portion of the local users 36.

The present invention also contemplates that various remote users located at remote nodes 31 and 34 may also access the GMRS server 30 over any suitable remote access connection, such as a web browser on the global computer network, remote access software, a VPN, or the like. For example, a remote grantor 12 located at remote node 31 can have access to the GMRS server 30 at the local node 28 via a remote connection 32. Similarly, a grantee 14 at a remote node may access the GMRS server 30 located at local node 28 via remote connection 35. It should be understood that authorized third parties 20 located at remote nodes, such as remote node 34, may access the system in a similar manner.

Thus, the present invention contemplates that the GMRS server 30 can be located at a hosting site and can be accessed by the grantees, grantors, payment systems, and authorized third parties remotely. Similarly, a large grantee or grantor, for example, may have the GMRS server 30 located locally to facilitate the grant process.

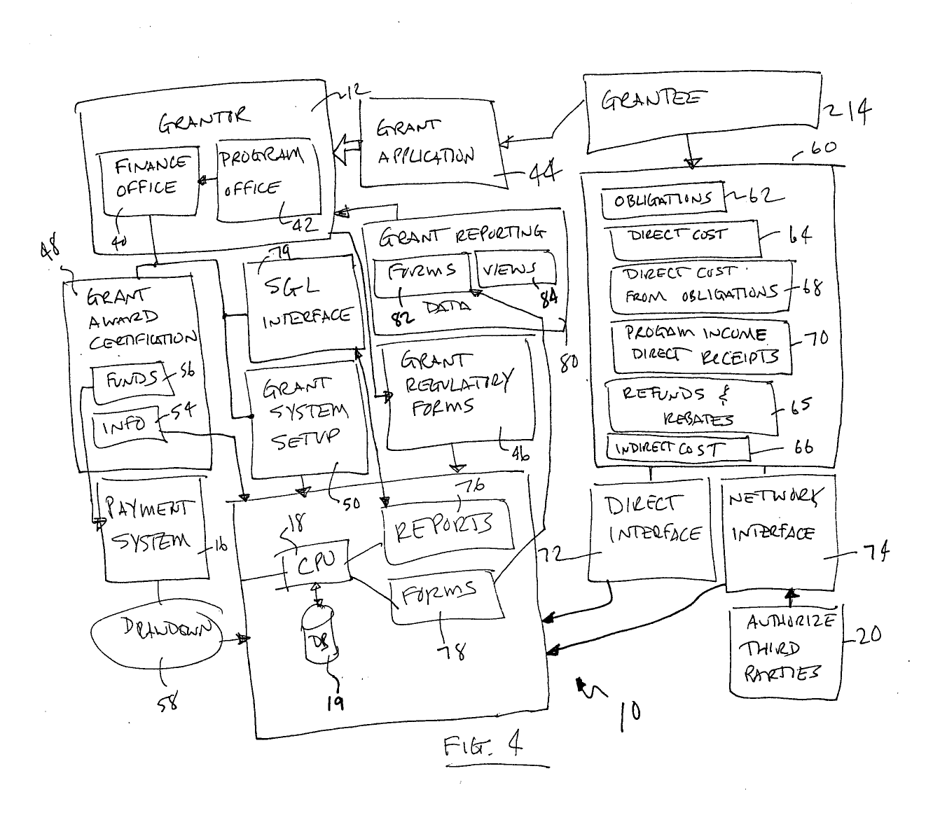

Referring now to FIG. 4, an overall schematic representation of the GMRS 10 is illustrated. The GMRS 10 includes the GMRS server 30 having a CPU 18 and a data store 19. A typical grantor agency 12 and a typical grantee 14 are shown along with a representative payment system module 16 and a third party auditor module 20. For purposes of this discussion, the grantee 14 initially makes a grant application 44 with a grantor 12.

Typically, the grantor agency 12 includes a program office 42 and a finance office 40. The program office 42 administers the grant application 44 and determines whether to issue the grant to a particular grantee 14. The program office 42 determines the grant regulatory forms 46 that are to be used to administer the grants. For example, many US federal agencies administer grants using a Financial Status Report (short) 269A, a Financial Status Report (long) 269, a Request for Advance or Reimbursement 270, and a Federal Cash Transaction Report 272. These forms set forth the reporting requirements of the grantee during the grant process. Today, the forms are filled out either manually or part of an automated process by the grantee; however, compliance with the grantor's requirements cannot be determined until the forms are submitted to the grantor by the grantee. In the present invention, however, the GMRS server 30 sits between the grantor and grantee and all transactions relating to the grant must go through the GMRS system 10 in detailed form, summary form, or directly imported and are recorded therein. It should be understood that any suitable forms to be used by the grantor agency 12 may be incorporated into the present invention. The flexibility of the GMRS 10 allows that the use of any grantor agencies 12 forms can be customized for any particular grant system.

Once the grant is approved, the grantor finance office 40 determines the amount of funds to be made available under the grant. To effect this, the finance office 40 issues a grant award certification 48, and enters set-up data into the grant system model 50 of the GMRS 10. The grant system set-up module 50 and the associated data is described in greater detail below.

Thus, the program office 42 enters the appropriate grant regulatory forms 46 to be used into the GMRS local server 30. The grantor financial office 40 has access to the GMRS server 30 to enter the grant setup data and system setup data 50 directly with the GMRS local server 30. If a payment system 16 is being used to administer the grant funds, the grant information can be passed on to the appropriate payment system 16 when the grant award certification 48 is issued. Typically, the grant award certification includes funds 56 and information 54 pertaining to the grant. It is the funds 56 that are managed by the payment system 16 such that when a grant request is requested by the grantee 14 a drawdown 58 is effected and information pertaining to the drawdown is passed to the GMRS server 30.

The grantee 14 has access to the GMRS server 30 via the grantee data entry module 60. In this way the grantee enters grant-related and other identification, financial, and other data into the GMRS server 30. The GMRS server 30 uses this data in conjunction with the grantor's Grant System set-up 50 to enable the grantor, the grantee, third parties, or the like to track the status of the grant, such as the grantee's compliance with the performance criteria, the financial status of the grant, and the like. As the grant funds are requested and spent by the grantee, the grantee enters the appropriate data related to the transaction in the data entry module 60. The most common data entries made in the grantee data entry module include obligation entries 62, direct cost entries 64, indirect cost entries 66, direct cost obligation 68, program income entries 70, and the like. Of course, the present invention contemplates that any type of data entry pertinent to the grant can be incorporated into the present invention. The data entries described in connection with the preferred embodiment are used in connection with administrating grants from U.S. federal agencies. The grantee data entries 60 can be effected through either a direct interface 72 or a network interface 74, as described above, depending upon the location of the GMRS service 30 and the needs of the user. Ultimately, the data entered by the grantee in the data entry area module 60 is accessible to the grantor, and possibly other grantees and other third party auditors. Referring back to the grant system set-up area 50 a grantor 12 initializes a new grant or may edit an existing grant in this step. Information necessary to administer the grant is entered by the grantor when the grant is initialized. Such information can be related to the grant itself, the funding of the grant, a project or object related to the grant, and other administrative tasks. Single or multiple grants can be set-up in the grant system setup module 50. For a single grant setup, one grant is set up. Typically, in a single grant setup the following information is required: Grant entry, fund entry, project entry, object codes, quick codes (processing profiles), class codes, transaction type, document profile, chart of account maintenance, allotments, sub-allotments, and email set up. When multiple grants are setup, a batch process can be used. The batch setup allows the elements of the single grant setup to be batch entered in a automated posting that can produce a general ledger posting where applicable. The invention contemplates that information can be imported directly from the grantor's electronic file. To effect this, a header record and a detail record are established. The header record contains general grant information that will be common to all of the grants entered in the batch setup. Similarly, the detail record contains details that are specific to one of the grants being set up in bath process.

The data entered by the grantor in the grant system setup 50 and the data entered by the grantee during the grantee data entry 60 is used by GMRS 10 to administer the grant. In this way, the GMRS 10 acts like a one-stop clearing house for all information pertinent for users to administer grants.

The GMRS 30 generates various forms 78 and reports 76 that enable users of the system to administer the grants. The grantor 12 can view these generated grant reporting forms 82 and the various available views 84. In addition, data can be exported directly to the grantor via a standard general ledger (SGL) interface 79 which runs as part of the GMRS program and formats the data in proper SGL format. In this way exported data can be transmitted directly into the grantor's financial software program from the GMRS 10.

The grantor is able to view the data entered by the grantee directly by accessing the GMRS 10. Various predefined views are available to the grantor to facilitate viewing the grant data, such as a grant view which provides a summary of the grant for all critical totals for a defined period, project/activity/function view, a transaction register which provides all general ledger posting information for all transactions with a defined range, an indirect cost register which provides indirect costs associated with a particular grant or all grants, an obligation register, a receipts register, a refunds and rebates register, print options, and performance indicators and measurement. Many of these views are described in connection with the grantee data entry described below. The system 10 also provides the grantor with the ability to view the data using predefined or pre-selected forms 78, such as standard U.S. federal government agency forms, as described below. For example, that grantor is able to view and print a Financial Status Report form 269 that is populated with data that has been entered in by the grantee during the grantee data entry process 60.

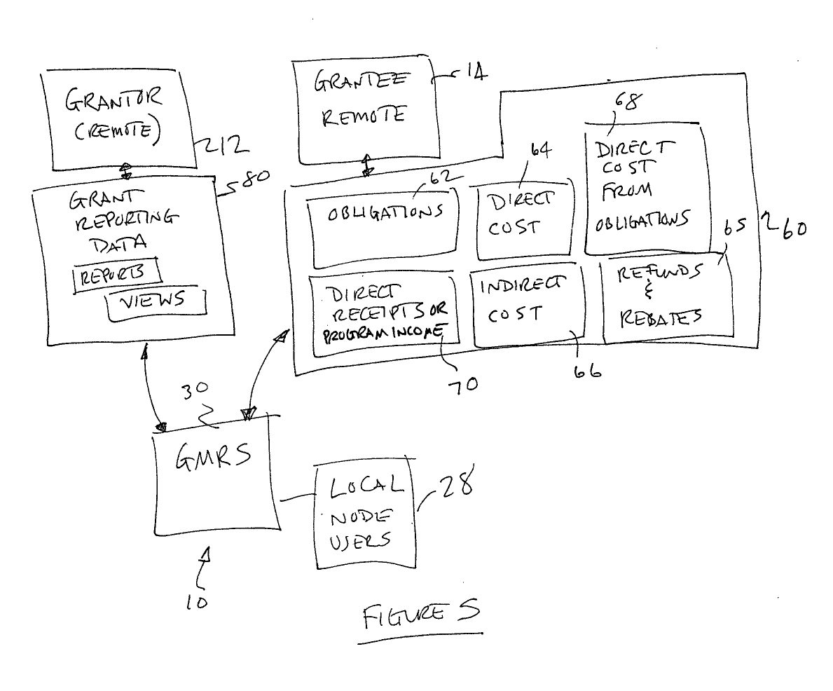

Referring now to FIG. 5, the GMRS 10 is illustrated with a typical arrangement of a remote grantor 12 and a remote grantee 14. Preferably, the remote grantee 14 interfaces with the GMRS 10 via a document entry module 60 in which financial transactions of the grant are recorded and transmitted to the GMRS 10 using a form document entry paradigm. The forms available to the grantee in document entry module 60 include obligation entry 62, direct cost entry 64, direct cost entry from obligations 68, refunds and rebates entry 65, grant receipts entry or program income 70, and indirect cost entry 66. Other types of grantee entry also fall within the scope of the present invention. For the purposes of the present discussion, the typical forms that are populated with the data gathered via this grantee document entry 62 will be the U.S. federal forms as described above. The various document entry forms available to the grantee will now be described in greater detail.

The obligation document entry 62 includes entry of funds that have been set aside to pay expenditures incurred within the budget period of the grant but which have not been paid prior to the preparation of the forms 269 or 269A. Typically the obligation entry 62 includes a spending category for the classification of various expenditures that the grantee will incur.

The direct cost entry 64 includes the entry of expenditures and allowable costs that were not included as obligations. These amounts are reported on Form 269A, 269, and 272. Typically, the direct cost entry 64 includes a spending category, and a vendor, and an outlay type.

The direct cost entry from obligation 68 records payments against previously entered obligations which can only be entered against a valid obligation number. This information is reported on Form 269A and 269. The data gathered in this step typically includes an identification of the obligation, an amount, and a vendor.

The refunds and rebates entry 65 includes entry of refunds or rebates to be offset against program outlays on Forms 270, 269A, 269 and 272. Typically the data gathered in this step includes vendor information and a processing profile. The processing profile is a shortcut whereby a single code represents a combination of data elements, such as program, project, grant, organization, and transaction type.

The direct receipts/program income entry 70 allows entry for all receipts or income under the grant. There is a selection for federal receipts and other receipts typically. For the federal grant income type amounts entered for letters of credit drawdown are entered on Form 272, amounts entered for treasury checks received are entered on Form 272, and amounts entered for automatic transfers received. For other income types, program income is entered on Form 269, interest income is entered on Form 272 and 269A, in-kind services are entered on Form 269 and 269A. Other federal matching funds are entered as federal awards that are authorized to be used to make the award on Form 269, and non-federal matching funds are entered on Form 270 and are used to calculate the federal share of the net program outlays.

For indirect costs entry 66, this function allows the entry of indirect costs, such as facilities and administrative costs, to be applied to a grant as a percentage rate approved by the federal government. The indirect cost entry 66 are answered on Form 269, 269A, 270, and 272. Typically, these indirect costs entry include a rate which is allocated to the grant to compute its percentage of indirect costs used along with the base amount to calculate a total amount. The base amount is entered as the amount of costs that have been expended by the facility. And, the total amount is calculated automatically by the base amount and the rate. The rate type can be a provisional, predetermined, final or fixed rate.

The invention also contemplates a security regime is implemented which includes features that ensure against improper or unauthorized use. Each user can be assigned a permission and a grant profile. The permission profiles are symbols that represent a complex combination of postings that provide access to various parts of the system. Profiles can specify access permissions. Administrators can designate a user's level of access to various system functions. The grant profile includes control the specific grantee data and access thereto that may be accessed by a particular user assigned that profile. These profiles can be set as to the access portal being used as well as the times that the software can be used.

The present invention is also able to exchange data directly with other external systems. For example, information can be imported or exported to the payment system 16 or can be imported or exported using the SGL interface 79 to a grantor's financial system. The US standard general ledger information, typically trial balances, detail and summary journal information, transaction register, and other information that auditors find helpful, may be imported and exported.

Another feature of the present invention is that the grantees may have their performance measured using the GRMS 10. This performance measurement aspect of the invention allows collection of milestones and performance notices that are computed against expenditures and outlays. For example, performance criteria can be defined during the grantor system set up 50. The fields represent different metrics, such as miles of highway completed, number of students graduated, number of patients treated, number of housing constructed, based upon the needs of the grantor. When the grantee enters the required performance related data in setup module 60, this data is matched-up with the criteria set forth in the grantor system setup module 50. These metrics are computed along with the expenditures or outlays to data in order to measure performance. These results are shown on view screens, printed, or exported to other systems or the business intelligence web portals. The GMRS 10 may also be used to send notifications to the grantees, grantors, authorized third parties, and the like based on these performance criteria, such as compliance with various aspects thereof, such as meeting deadlines.

In use the GMRS 10 operates as follows. A grantee Applies for a grant 44 from a grantor 12. The grant application 44 ultimately is awarded. The Grant award document/certification 48 is sent to the Grantor's program office 42 and finance office 40. The GMRS 10 is capable of importing data directly from this process in step 54. The grantor finance office 40 can also access the GMRS 10 to enter grant system set-up data in module 50 either manually or through an export process. Grant information 56 is also provided to a payment system 16, such as ASAP or PMS. During the administration of the grant, the grantee enters transactions related to the data in the data entry module 60. Security features as included to permit and define authorized access. If the Grantee is using an in-house financial system, data can be imported from their system into the GMRS 10.

Payment drawdown 58 information can be entered based on the payment made by the payment system 16 being used, if any. If no payment system 16 is used, the grantee may enter the payment information directly into the GMRS 10. In addition, data can be imported from the payment system 16 into the GMRS 10.

Forms 82 can be printed or viewed by the grantor 12 accessing the GMRS 10 through their own access accounts. The forms are populated with the data from the grantee and/or the payment system 16. Appropriate security features are in place for the grantor's access. An optional Business Intelligence remote Portal 74, such as a web serves, may be used to access the grant data on the GMRS 10. This data may be retrieved and analyzed using the web portal 74 by authorized third parties, such as auditors.

Standardized data, such as U.S. Standard General Ledger postings, can be exported to the Grantor's in-house grant/finance managing system through the SGL interface 79 of the GMRS 10.

The present invention may be embodied in other specific forms without departing from the spirit or essential attributes thereof and, accordingly, reference should be made to the appended claims, rather than to the foregoing specification, as indicating the scope of the invention.

1. A system for managing and reporting grants comprising:
a processor and a data store;
at least one regulatory form associated with a grant which is used by a grantor to administer the grant;
a grant set-up module for collecting data associated with the grant which is stored in the data store; and
a grantee data entry module in which the grantee can enter data related to the grant set-up data which is stored in the data store, the grantee data and the grant set-up data can be compared by the processor to enable a grantor to track the status of the grant.

2. The grant managing and reporting system according to claim 1, wherein the grantee data is used to populate the at least one of the regulatory form.

3. The grant managing and reporting system according to claim 1, further comprising a payment system module for collecting funding data related to the grant disbursed by a payment system, the funding data is available to the grantor to administer the grant.

4. The grant managing and reporting system according to claim 1, further comprising a standard general ledger module for formatting system data in standard general ledger format for use in the grantor's financial software.

5. The grant managing and reporting system according to claim 1, wherein authorized third parties are permitted access to the system data.

6. The grant managing and reporting system according to claim 1, wherein the grant comprises performance criteria and in which the grantee data comprises data related to the performance criteria.

7. A method for managing and reporting grants comprising the steps of:
providing a processor and a data store;
providing at least one regulatory form associated with a grant which is used by a grantor to administer the grant;
providing a grant set-up module for collecting data associated with the grant which is stored in the data store;
providing a grantee data entry module in which the grantee can enter data related to the grant set-up data which is stored in the data store; and
comparing grantee data and the grant set-up data by the processor to enable a grantor to track the status of the grant.

8. The grant managing and reporting system according to claim 7, wherein the grantee data is used to populate the at least one of the regulatory form.

9. The grant managing and reporting system according to claim 7, further comprising the steps of:
providing a payment system module for collecting funding data related to the grant disbursed by a payment system, the funding data is available to the grantor to administer the grant.

10. The grant managing and reporting system according to claim 7, further comprising the steps of:
providing a standard general ledger module for formatting system data in standard general ledger format for use in the grantor's financial software.

11. The grant managing and reporting system according to claim 7, wherein authorized third parties are permitted access to the system data.

12. The grant managing and reporting system according to claim 7, wherein the grant comprises performance criteria and in which the grantee data comprises data related to the performance criteria.
